(19) United States
(12) Patent Application Publication
(10) Pub. No.: US 2007/0247712 A1
(43) Pub. Date: Oct. 25, 2007

(54) Optical elements having reverse dispersion

(75) Inventors: YuanQiao Rao, Pittsford, NY (US); Anne M. Miller, Batavia, NY (US)

Correspondence Address: Paul A. Leipold;Patent Legal Staff, Eastman Kodak Company, 343 State Street, Rochester, NY, 14650-2201, US

(73) Assignee: Eastman Kodak Company

(21) Appl. No.: 11/408,666

(22) Filed: Apr. 21, 2006

(51) Int. Cl. G02B 5/30

(52) U.S. Cl. 359/494; 359/383

(57) ABSTRACT

This invention relates to an optical element comprising a first component having a birefringence dispersion of D1>1, and a second component having a birefringence dispersion of D2>1 and a maximum peak absorption at a wavelength less than 400 nm, wherein the birefringence ratio at any wavelength of the first and second component is Δn1/Δn2<0, and wherein the optical element has a reverse birefringence dispersion of D<1.

### FIELD OF THE INVENTION

The invention relates to an optical element with reverse birefringence dispersion and the methods of making such elements. The invention particularly relates to optical films. The optical elements of the present invention are useful in the field of electronic display and other optical applications.

### BACKGROUND OF THE INVENTION

Liquid crystals are widely used for electronic displays. In these display systems, a liquid crystal cell is typically situated between a polarizer and an analyzer. Incident light polarized by the polarizer passes through a liquid crystal cell and is affected by the molecular orientation of the liquid crystal, which can be altered by the application of a voltage across the cell. The altered light goes into the analyzer. By employing this principle, the transmission of light from an external source, including ambient light, can be controlled.

Contrast, color reproduction, and stable gray scale intensities are important quality attributes for electronic displays which employ liquid crystal technology. The primary factor limiting the contrast of a liquid crystal display (LCD) is the propensity for light to “leak” through liquid crystal elements or cells, which are in the dark or “black” pixel state. The contrast of an LCD is also dependent on the angle from which the display screen is viewed. One of the common methods to improve the viewing angle characteristic of LCDs is to use compensation films. Birefringence dispersion is an essential property in many optical components such as compensation films used to improve the liquid crystal display image quality. Even with a compensation film, the dark state can have an undesirable color tint such as red or blue, if the birefringence dispersion of the compensation film is not optimized.

A material that displays at least two different indices of refraction is said to be birefringent. In general, birefringent media are characterized by three indices of refraction, nₓ, n_{y}, and n_{z}. The out-of-plane birefringence is usually defined by Δnₜₕ=n_{z}−(nₓ+n_{y})/2, where nₓ, n_{y}, and n_{z} are indices in the x, y, and z direction, respectively. Indices of refraction are functions of wavelength (λ). Accordingly, out-of-plane birefringence, given by Δnₜₕ=n_{z}−(nₓ+n_{y})/2, also depends on λ. Such a dependence of birefringence on λ is typically called birefringence dispersion. The in-plane birefringence is usually defined by Δnᵢₙ=nₓ−n_{y}, where nₓ and n_{y} are indices in the x and y directions, respectively. Indices of refraction are functions of wavelength (λ). Accordingly, in-plane birefringence, given by Δnᵢₙ=nₓ−n_{y} also depends on λ.

Out-of-plane retardation, Rₜₕ, is related to out of plane birefringence, Δnₜₕ, by Rₜₕ=Δnₜₕ×d, where d is the thickness of the optical element. Similarly, in plane retardation Rᵢₙ is related to in plane retardation Δnᵢₙ by Rᵢₙ=Δnᵢₙ×d.

In several generally used LCD modes, LCD displays suffer deterioration in contrast when the displays are viewed from oblique angles due to the birefringence of the liquid crystals and the crossed polarizers. Therefore, optical compensating is needed, normally with a retardance film with optimized in-plane and out-of plane retardation. The use of biaxial films has been suggested to compensate the optical-compensating-bend (OCB) (U.S. Pat. No. 6,108,058) and vertical alignment (VA) (JP1999-95208) LCDs.

Birefringence dispersion is an essential property in many optical components such as compensation films used to improve the liquid crystal display image quality. Adjusting out-of-plane Δnₜₕ dispersion, along with in-plane birefringence Δnᵢₙ dispersion, is critical for optimizing the performance of optical components such as compensation films. In most cases, films made by casting polymer have out-of-plane birefringence. Films made by stretching have in-plane birefringence. For simplicity, Δnₜₕ will be considered hereinafter. The Δnₜₕ can be negative (101) or positive (100) throughout the wavelength of interest, as shown in FIG. 1. In most cases, film made by casting polymer having a positive intrinsic birefringence, Δnᵢₙₜ, gives negative Δnₜₕ. Its dispersion is such that the Δnₜₕ value becomes less negative at longer wavelength (101). On the other hand, by casting polymer with negative Δnᵢₙₜ, one obtains a positive Δnₜₕ value with less positive Δnₜₕ value at longer wavelength (100). This dispersion behavior, in which the absolute value of Δnₜₕ decreases with the increasing wavelength, is called “normal” dispersion.

In contrast to normal dispersion, it is often desirable to have the absolute value of Δnₜₕ increase with the increasing wavelength, which is called “reverse” dispersion (curves 102 and 103 in FIG. 1). Hereinafter, dispersion constant is defined as
D=Δn(450 nm)/Δn(590 nm)

Thus, the optical component has a reverse dispersion when
D<1

These cases of different behaviors in Δnₜₕ in principle can be achieved by a suitable combination of two or more layers having different dispersion in Δnₜₕ. Such an approach, however, is difficult, as one has to carefully adjust the thickness of each layer. Also, extra process steps are added to manufacturing.

U.S. Pat. No. 6,565,974 discloses controlling birefringence dispersion by means of balancing the optical anisotropy of the main chain and side chain chromophore group of a polycarbonate. Both chromophores in the main chain and side chain have normal dispersion but are arranged in a perpendicular orientation and thus have different signs of birefringence, a positive dispersive segment A 200 and a negative dispersive segment B 201 as shown in FIG. 2. The combination of them can be finely tuned. This method enables the generation of a polymer having smaller birefringence (or equivalent smaller retardation value) at shorter wavelength, a reverse dispersion material 203 according to the schematics of FIG. 2. However, the incorporation of two balancing chromophores makes the final material less birefringent. Thus, thick films are needed to achieve adequate retardation. In addition, the materials used require custom synthesized polymer and are expensive.

### PROBLEM TO BE SOLVED BY THE INVENTION

The problem to be solved is to develop a material with reverse birefringence dispersion. It is desirable to develop a material with reverse birefringence dispersion comprising a component having inherent reverse dispersion. It is especially desirable to be able to easily make such materials into films that can be used as compensation films for display devices, particularly LCDs.

### SUMMARY OF THE INVENTION

This invention provides an optical element comprising a first component having a birefringence dispersion of D1>1, and a second component having a birefringence dispersion of D2>1 and a maximum peak absorption at a wavelength less than 400 nm; wherein D2>D1; wherein the birefringence ratio of the first and second component at any wavelength is Δn1/Δn2<0; and wherein the optical element has a reverse birefringence dispersion of D<1.

This invention further provides an LCD polarizer film composite comprising a first component having a birefringence dispersion of D1>1 and a second component having a birefringence dispersion of D2>1 and a maximum peak absorption at a wavelength less than 400 nm, wherein the birefringence ratio of the first and second component at any wavelength is Δn1/Δn2<0, wherein the optical film has a reverse birefringence dispersion of D<1.

This invention provides an optical element with reverse dispersion behavior that is effective and easy to manufacture.

### BRIEF DESCRIPTION OF THE DRAWINGS

The embodiments are best understood from the following detailed description when read with the accompanying drawing figures. It is emphasized that the various features are not necessarily drawn to scale. In fact, the dimensions may be arbitrarily increased or decreased for clarity of discussion.

FIG. 1 is a graph showing various birefringence dispersion behaviors, including positive and negative out-of-plane dispersion and reverse dispersion and normal dispersion.

FIG. 2 is a graph showing a reverse dispersion copolymer comprising positive and negative out-of-plane birefringence exhibiting normal dispersion.

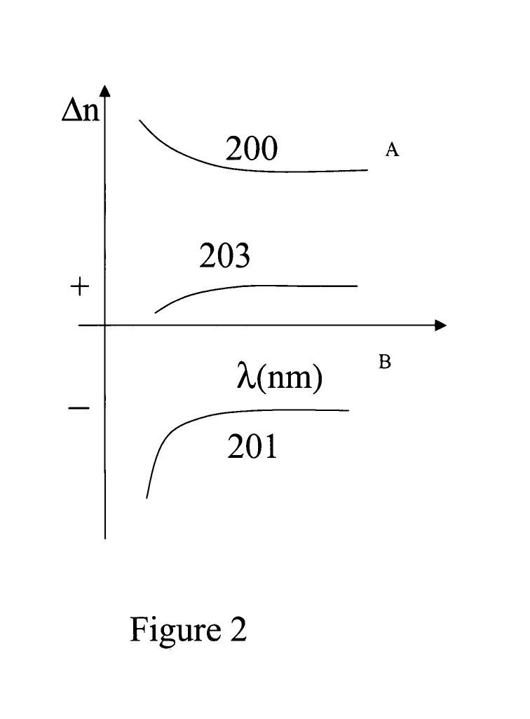

FIG. 3 illustrates an exemplary film having a thickness d and dimensions in the “x”, “y,” and “z” directions in which x and y lie perpendicularly to each other in the plane of the film, and z is normal the plane of the film.

FIG. 4 shows a polymeric film in which the polymer chains have a statistically averaged alignment direction.

FIG. 5 is a schematic of the inventive material comprising two components

FIG. 6 is a schematic of the effect of optical residue of a UV absorbing group

FIG. 7 is a schematic of the different refractive indices in a UV absorbing group

FIG. 8 is a schematic of a UV absorbing group with high birefringence dispersion

FIG. 9 is a birefringence spectrum of Example 7.

### DETAILED DESCRIPTION OF THE INVENTION

The invention has been described with reference to preferred embodiments. However, it will be appreciated that variations/modifications of such embodiments can be affected by a person of ordinary skill in the art without departing from the scope of the invention.

As mentioned above, the present invention provides a new material and method for forming materials having desired out-of-plane birefringence (Δnₜₕ) behavior. The invention can be used to form a flexible film that has high optical transmittance or transparency and low haze. These and other advantages will be apparent from the detailed description below.

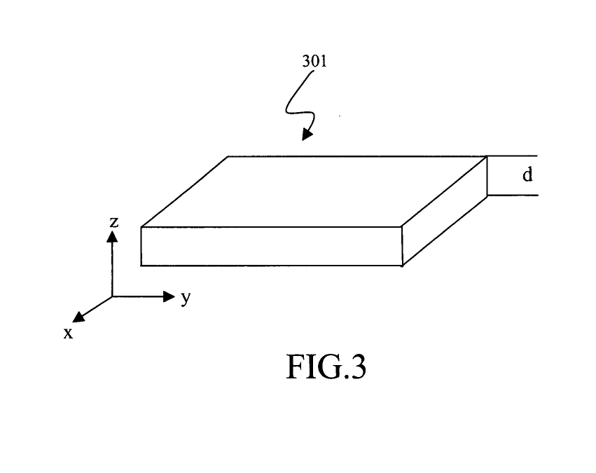

With reference to FIG. 3, the following definitions apply to the description herein:

The letters “x”, “y,” and “z” define directions relative to a given film (301), where x and y lie perpendicularly to each other in the plane of the film, and z is normal the plane of the film.

The term “optic axis” refers to the direction in which propagating light does not see birefringence. In polymeric material, the optic axis is parallel to the polymer chain.

The terms “nₓ,” “n_{y},” and “n_{z}” are the indices of refraction of a film in the x, y, and z directions, respectively.

A “C-plate” refers to a plate or a film in which nₓ=n_{y}, and n_{z} differs from nₓ and n_{y}. Usually, when materials are cast into a film, the film possesses the property of a C-plate.

The term “intrinsic birefringence (Δnᵢₙₜ)” with respect to a polymer or mineral refers to the quantity defined by (nₑ-nₒ), where nₑ and nₒ are the extraordinary and ordinary index of the polymer or mineral, respectively. Intrinsic birefringence of a polymer is determined by factors such as the polarizabilities of functional groups and their bond angles with respect to the polymer chain. Indices of refraction nₓ, n_{y}, and n_{z} of a polymer article, such as a film, are dependent upon manufacturing process conditions of the article and Δnᵢₙₜ of the polymer. nₓ, n_{y}, and n_{z} are conveniently defined according to the coordinates of the film, i.e, nₓ, n_{y}, are two in-plane indexes and n_{z} is the out of plane index as shown in FIG. 3.

The term “out-of-plane phase retardation (Rₜₕ)” of a film is a quantity defined by [n_{z}−(nₓ+n_{y})/2]d, where d is the thickness of the film 301 as shown in FIG. 3. The quantity [n_{z}−(nₓ+n_{y})/2] is referred to as the “out-of-plane birefringence (Δnₜₕ)”.

The term “in-plane birefringence” with respect to a film 301 is defined by |nₓ-n_{y}|. The quantity |nₓ−n_{y}|d is referred to as the “in-plane retardation (Rᵢₙ)”.

The birefringence is a quantity dependent on the wavelength of the light. This wavelength dependence is birefringence dispersion. To quantify the birefringence dispersion, the term “D” is defined as the ratio of the birefringence at wavelength 450 nm to the birefringence at 590 nm: D=Δnₜₕ (450 nm)/Δnₜₕ (590 nm).

The molar extinction coefficient (ε) describes how strongly a material absorbs light and is defined as

ε=A/cl where A=absorbance, c=sample concentration in moles/liter and l=length of light path through the cuvette in cm. The molar extinction coefficient (s) is a function of the wavelength. The maximum molar extinction coefficient of a strong absorbing material usually is higher than 10,000 while the extinction coefficient of a weak absorbing material is less than 100.

The optical element of this invention comprises a first component that has a birefringence dispersion of D₁>1, and preferably a birefringence dispersion wherein D₁<1.05. The second component has a birefringence dispersion of D₂>1, and preferably a birefringence dispersion of D₂>D1. A birefringence dispersion of D=1 means that the birefringence of the optical element is a constant and does not change with the wavelength. A first component having a birefringence dispersion of D₁>1 means a component having a normal birefringence dispersion. A second component having a birefringence dispersion of D₂>1 means a second component having a normal birefringence dispersion. A second component having a birefringence dispersion of D₂>D1 means the second component has a higher normal birefringence dispersion than the first component. When the birefringence ratio of the first and second component is Δn1/Δn2<0, it means the two components have opposite signs of birefringence. The resulting optical element must have a reverse birefringence dispersion of D<1. Preferably the optical element has a reverse birefringence dispersion of D<0.95.

It is preferred that the first component be a polymer. As noted above, for a polymeric material, the indices nₓ, n_{y}, and n_{z} result from the Δnᵢₙₜ of the material and the process of forming the film. Various processes, e.g., casting, stretching and annealing, give different states of polymer chain alignment. This, in combination with Δnᵢₙₜ, determines nₓ, n_{y}, n_{z}. Generally, solvent-cast polymer film exhibits small in-plane birefringence (<10⁻⁴ to 10⁻⁵ at λ=550 nm). Depending on the processing conditions and the kind of polymer, however, Δnₜₕ can be larger.

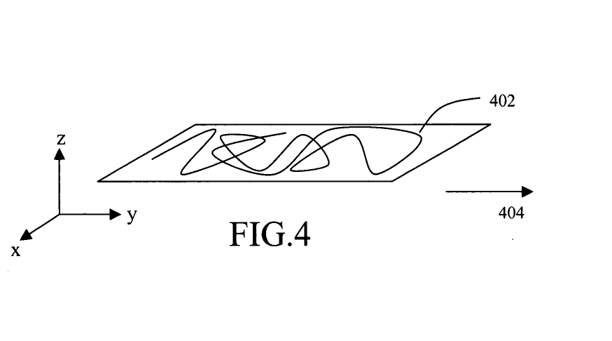

The mechanism of generating Δnₜₕ can be explained by using the concept of the order parameter, S. As is well known to those skilled in the art, the out-of-plane birefringence of the polymer film is given by Δnₜₕ=SΔnᵢₙₜ. As mentioned above, Δnᵢₙₜ is determined only by the properties of the polymer, whereas the process of forming the film fundamentally controls S. S is usually positive and S<1, if the polymer chains (402) in a polymeric film have a statistically averaged alignment direction (404), as shown in FIG. 4. In order to obtain negative Δnₜₕ, a polymer having positive Δnᵢₙₜ is used, while for positive Δnₜₕ, ones with negative Δnᵢₙₜ is employed. In both cases, one has the property of a C-plate having nₓ=n_{y}.

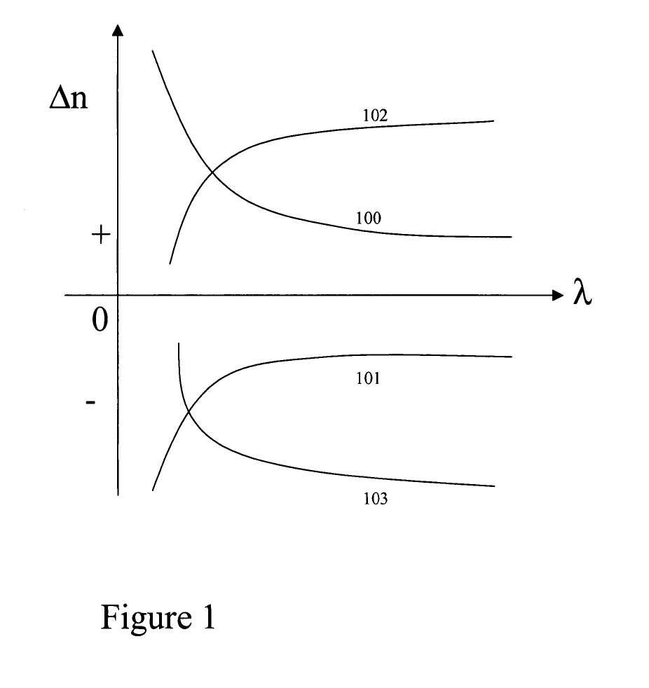

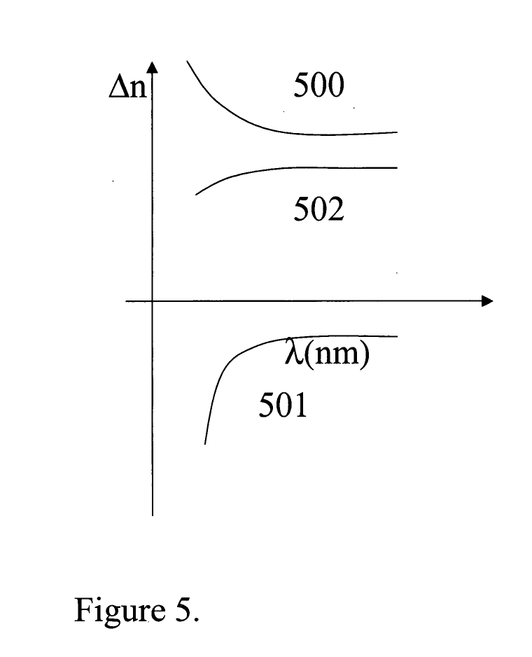

The Δnᵢₙₜ dispersion behavior of most of polymer materials is normal, that is, the absolute values of birefringence decreases at longer λ as curve 100 and 101 in FIG. 1. This also gives normal dispersion behavior in Δnₜₕ. In accordance with the present invention, the dispersion behavior of a film is controlled by an optical material having two components, wherein both of them have normal birefringence. A reverse dispersion material can be formed by having two components and arranging their relative orientation such that their individual birefringences behave as normal polymer 500 and normal dispersive additive 501 in FIG. 5 and the final material has a reverse birefringence dispersion like composite material 502. For the purpose of illustration, only a positive birefringence polymeric material is plotted. The negative birefringence material can be formed according to the same method.

In order to form the optical element of this invention, the second component has to be a lower amount by volume than the first component such that the final film has the same sign of birefringence as the first component. The amount of the second component is determined by the required value of birefringence dispersion (D). The lower the birefringence dispersion (D) is, the more of the second component is needed. It is preferred that the second component is greater than 5% of the first component. It is more preferred that the second component is greater than 15% of the first component.

The optical element of this invention can further comprise a third component with an absorption maximum peak at a wavelength greater than 700 nm. The third component is preferred to have the same sign of birefringence as the first component, which is preferably a polymer. The third component is also preferred to have a reverse birefringence dispersion of D3<1. The addition of the third component can enhance the reverse birefringence of the optical element.

When the first component is a polymer it is preferred that the polymer be transparent in the visible range. In general a preferred polymer is a vinyl polymer or a condensation polymer.

The polymers are polymers with chromophores, which is necessary to have inherent birefringence. The term “chromophore” is defined as an atom or group of atoms that serve as a unit in light adsorption. (Modern Molecular Photochemistry, Nicholas J. Turro, Ed., Benjamin/Cummings Publishing Co., Menlo Park, Calif. (1978), pg 77.)

Typical chromophore groups for use in the polymers in the present invention include vinyl, carbonyl, amide, imide, ester, carbonate, aromatic (i.e., heteroaromatic or carbocylic aromatic such as phenyl, naphthyl, biphenyl, thiophene, bisphenol), sulfone, and azo or combinations of these chromophores. A non-visible chromophore is one that has an absorption maximum outside the range of λ=400-700 nm.

The relative orientation of the chromophore to the optical axis of a polymer chain determines the sign of Δnᵢₙₜ. If placed in the main chain, the Δnᵢₙₜ of the polymer will be positive and, if the chromophore is placed in the side chain, the Δnᵢₙₜ of the polymer will be negative.

Examples of negative Δnᵢₙₜ polymers include materials having non-visible chromophores off of the polymer backbone. Such non-visible chromophores, for example, include: vinyl, carbonyl, amide, imide, ester, carbonate, sulfone, azo, and aromatic heterocyclic and carbocyclic groups (e.g., phenyl, naphthyl, biphenyl, terphenyl, phenol, bisphenol A, and thiophene). In addition, combinations of these non-visible chromophores may be desirable (i.e., in copolymers). Examples of such polymers and their structures are poly(methyl methacrylate), poly(4 vinylbiphenyl) (Formula I below), poly(4 vinylphenol) (Formula II), poly(N-vinylcarbazole) (Formula III), poly(methylcarboxyphenylmethacrylamide) (Formula IV), polystyrene, poly[(1-acetylindazol-3-ylcarbonyloxy)ethylene] (Formula V), poly(phthalimidoethylene) (Formula VI), poly(4-(1-hydroxy-1-methylpropyl)styrene) (Formula VII), poly(2-hydroxymethylstyrene) (Formula VIII), poly(2-dimethylaminocarbonylstyrene) (Formula IX), poly(2-phenylaminocarbonylstyrene) (Formula X), poly(3-(4-biphenylyl)styrene) (XI), and poly(4-(4-biphenylyl)styrene) (XII),

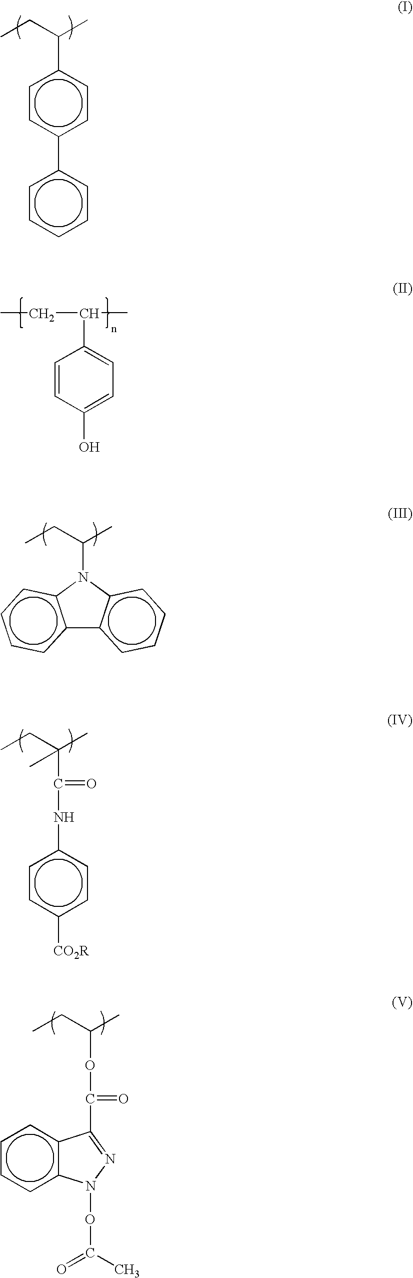

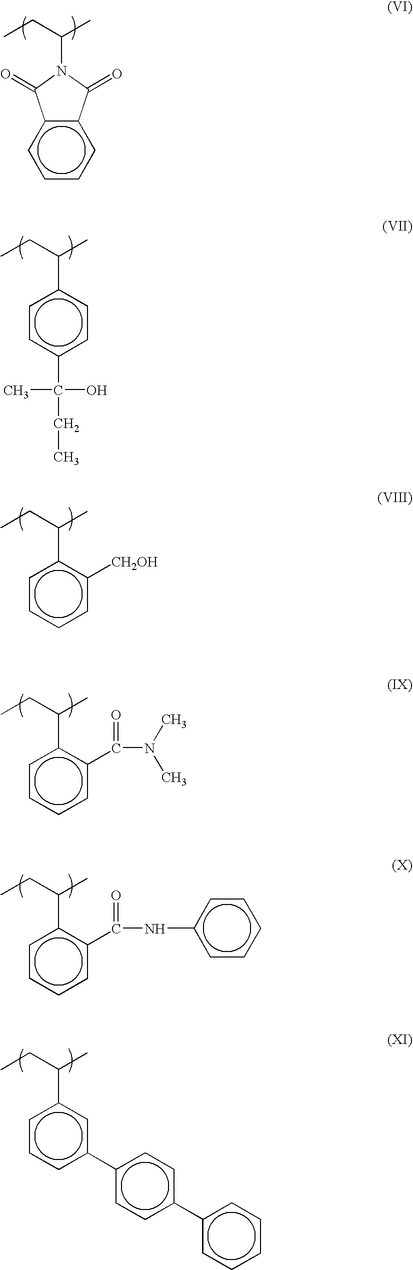

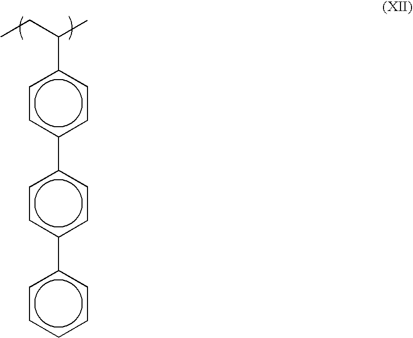

Examples of positive Δnᵢₙₜ polymers include materials that have non-visible chromophores on the polymer backbone. Such non-visible chromophores, for example, include: vinyl, carbonyl, amide, imide, ester, carbonate, sulfone, azo, and aromatic heterocyclic and carbocyclic groups (e.g., phenyl, naphthyl, biphenyl, terphenyl, phenol, bisphenol A, and thiophene). In addition, polymers having combinations of these non-visible chromophores may be desirable (i.e., in copolymers). Examples of such polymers are polyesters, polycarbonates, polysulfones, polyketones, polyamides, and polyimides containing the following monomers:

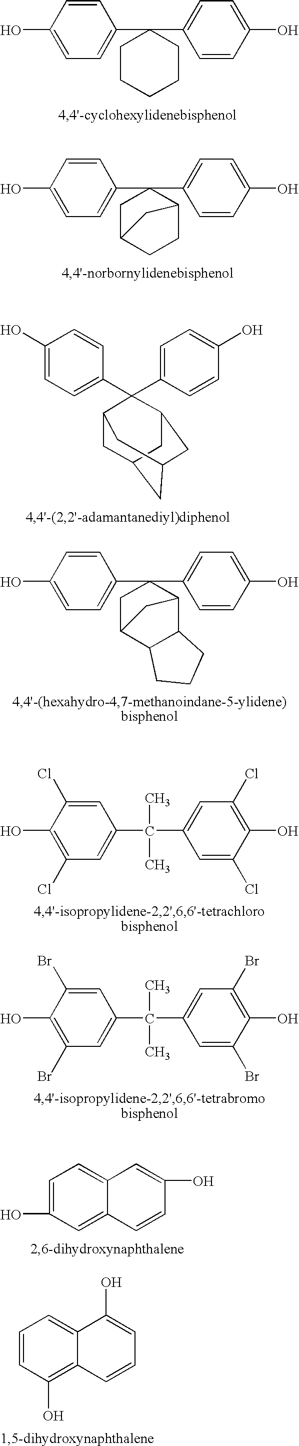

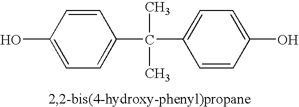

The following Table I lists various values for intrinsic birefringence Δnᵢₙₜ for typical polymers used in optical elements:

TABLE 1

| | |
|---|---|
| Polystyrene | Δnᵢₙₜ = −0.100 |
| Polyphenylene oxide | Δnᵢₙₜ = +0.210 |
| Bisphenol A Polycarbonate | Δnᵢₙₜ = +0.106 |
| Polymethyl methacrylate | Δnᵢₙₜ = −0.0043 |
| Polyethylene terephthalate | Δnᵢₙₜ = +0.105 |

As evident by the Δnᵢₙₜ value, acrylic polymers, for example polystyrene (PS), and poly(vinylcarbazole) are preferred for obtaining positive reverse birefringence according to the present invention. A preferred polymer for obtaining negative reverse dispersion is a positive Δnᵢₙₜ polymer such as polyphenylene oxide and polycarbonate.

The second component may be any compound that meets the parameters discussed above. Preferably the second component has a maximum peak absorption at a wavelength less than 400 nm, more preferably between 300 and 400 nm, and does not absorb in the visible range. It is a so-called UV-ray absorbing compound or UV dye. More preferably the second component has an extinction coefficient at its maximum absorbing peak higher than 10000. While the second component may be a polymer it is preferred that the second component has a molecular weight of less than 2000. In one embodiment the second component is an organic component. In another embodiment the second component may be covalently attached to the polymer.

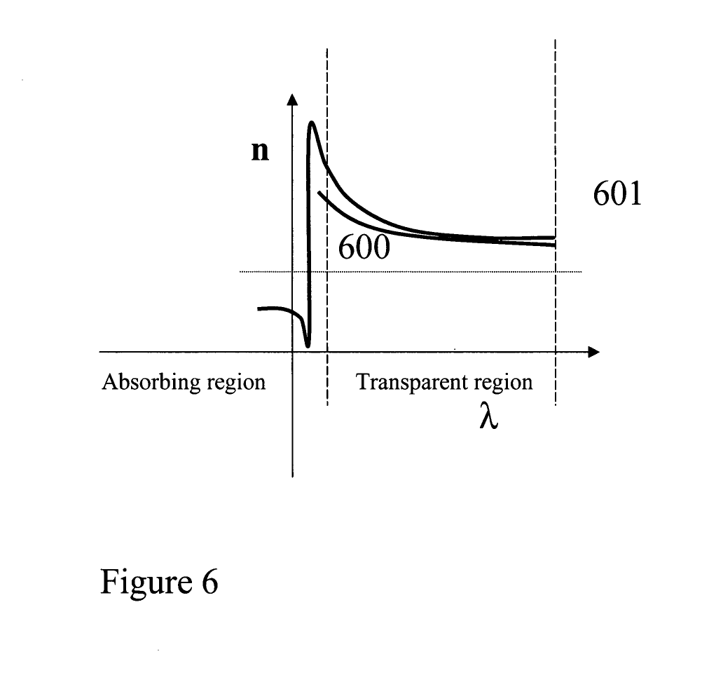

Optical residues are known in optical physics. (ref. 1. Wooten, Optical Properties of Solids, Academic Press, 1972). This reference describes that the high energy absorption peaks (UV absorbing) increase n at higher energies (shorter visible wavelength) even in transparent spectral regions as shown in FIG. 6. For a normal material possessing a refractive index behavior as in 600, the index behavior changes to 601 when a UV absorbing chromophore presents. It is noticeable that when the absorbing maximum peak is below 400 nm (UV absorbing), the material is transparent in the visible range (450 nm to 650 nm). It is further noticeable that the refractive index increases more with the decreasing wavelength and its dispersion is increased with the presence of the UV absorbing group.

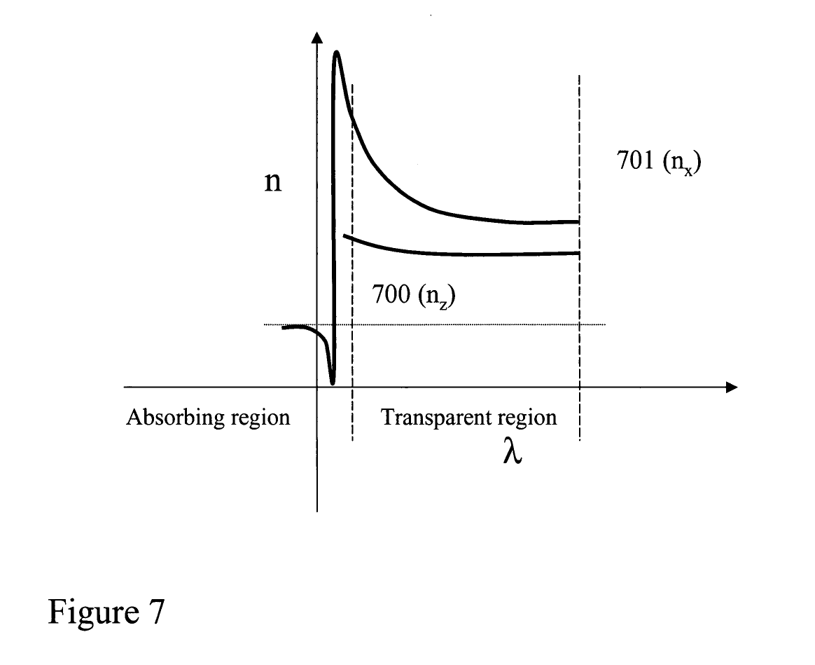

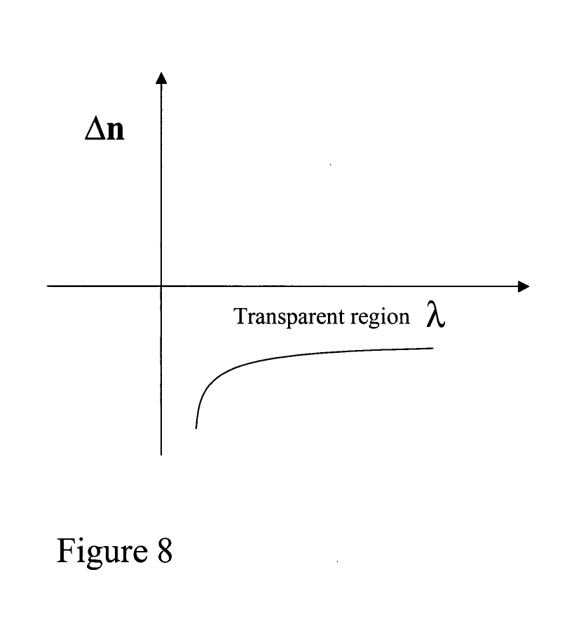

It is known that UV absorbing groups often behave dichroic, in which the absorbing is anisotropic (ref. 2. A V Ivashchenko Dichroic Dyes for Liquid Crystal Displays CRC Press) Therefore, its optical residue effect will also be anisotropic. The effect is shown in FIG. 7 that the nₓ (701) has lower refractive index and lower refractive index dispersion, while the n_{z} (700) has higher refractive index and higher refractive index dispersion. The birefringence formed is then negative birefringence with high birefringence dispersion as shown in FIG. 8.

The UV ray-absorbing dyes favorably used in the invention include commercially available dyes and publicly known dyes described in the literature. It can be a benzophenone, benzotriazole, trazine, oxanilide or cyanoacrylate. Specific examples include hydroxybenzophenone, 2-hydroxyphenylbenzotriazole, 2-hydroxyphenyltriazine, oxanilide; 2-hydroxyphenylbenzotriazole. The hydroxybenzophenone can be 2,4-dihydroxybenzophenone, 2-hydroxy-4-methoxybenzophenone, 2-hydroxy-4-octyloxybenzophenone, 2-hydroxy-4-decyloxybenzophenone, 2-hydroxy-4-dodecyloxybenzophenone, 4,2′,4′-trihydroxybenzophenone and 2′-hydroxy-4,4′-dimethoxybenzophenone; the 2-hydroxyphenylbenzotriazole is selected from the group consisting of 2-(2′-hydroxy-5′-methylphenyl)-benzotriazole, 2-(3′,5′-di-tert-butyl-2′-hydroxyphenyl)benzotriazole, 2-(5′-tert-butyl-2′-hydroxyphenyl)benzotriazole, 2-(2′-hydroxy-5-(1,1,3,3-tetramethylbutyl) phenyl)benzotriazole, 2-(3′,5′-di-tert-butyl-2′-hydroxyphenyl)-5-chloro-benzotriazole, 2-(3′-tert-butyl-2′-hydroxy-5′-methylphenyl)-5-chloro-benzotriazole, 2-(3′-sec-butyl-5′-tert-butyl-2′-hydroxyphenyl) benzotriazole, 2-(2′-hydroxy-4′-octyloxyphenyl) benzotriazole, 2-(3′,5′-di-tert-amyl-2′-hydroxyphenyl)benzotriazole, 2-(3′,5′-bis-(α,α-dimethylbenzyl)-2′-hydroxyphenyl) benzotriazole, 2-(3′-tert-butyl-2′-hydroxy-5′-(2-octyloxycarbonylethyl) phenyl)-5-chloro-benzotriazole, 2-(3′-tert-butyl-5′-[2-(2-ethylhexyloxy)-carbonylethyl]-2′-hydroxyphenyl)-5-chloro-benzotriazole, 2-(3′-tert-butyl-2′-hydroxy-5′-(2-methoxycarbonylethyl)-5-chloro-benzotriazole, 2-(3′-tert-butyl-2′-hydroxy-5′-(2-methoxycarbonylethyl)phenyl) benzotriazole, 2-(3′-tert-butyl-2′-hydroxy-5′-(2-octyloxy-carbonylethyl) phenyl)benzotriazole, 2-(3′-tert-butyl-5′-[2-(2-ethylhexyloxy) carbonylethyl]-2′-hydroxyphenyl) benzotriazole, 2-(3′-dodecyl-2′-hydroxy-5′-methylphenyl)benzotriazole, 2-(3′-tert-butyl-2′-hydroxy-5′-(2-isooctyloxycarbonylethyl) phenylbenzotriazole, 2,2′-methylene-bis[4-(1,1,3,3-tetramethylbutyl)-6-benzotriazole-2-ylphenol]; the transesterification product of 2-[3′-tert-butyl-5′-(2-methoxycarbonylethyl)-2′-hydroxyphenyl]-2H-benzotriazole with polyethylene glycol 300; [R—CH₂CH₂—COO—CH₂CH₂)₂ where R=3′-tert-butyl-4′-hydroxy-5′-2H-benzotriazol-2-ylphenyl, 2-[2′-hydroxy-340-(α,α-dimethylbenzyl)-5′-(1,1,3,3-tetramethylbutyl)phenyl]benzotriazole and 2-[2′-hydroxy-3′-(1,1,3,3-tetramethylbutyl)-5′-(α,α-dimethylbenzyl)-phenyl]benzotriazole; the 2-hydroxyphenyltriazine is selected from the group consisting of 2,4,6-tris(2-hydroxy-4-octyloxyphenyl)-1,3,5-triazine, 2-(2-hydroxy-4-octyloxyphenyl)-4,6-bis(2,4-dimethylphenyl)-1,3,5-triazine, 2-(2,4-dihydroxyphenyl)-4,6-bis(2,4-dimethylphenyl)-1,3,5-triazine, 2,4-bis(2-hydroxy-4-propyloxyphenyl)-6-(2,4-dimethylphenyl)-1,3,5-triazine, 2-(2-hydroxy-4-octyloxyphenyl)-4,6-bis(4-methylphenyl)-1,3,5-triazine, 2-(2-hydroxy-4-dodecyloxyphenyl)-4,6-bis-2,4-dimethylphenyl)-1,3,5-triazine, 2-(2-hydroxy-4-tridecyloxyphenyl)-4,6-bis(2,4-dimethylphenyl)-1,3,5-triazine, 2-[2-hydroxy-4-(2-hydroxy-3-butyloxy-propoxy)phenyl]-4,6-bis(2,4-dimethyl)-1,3,5-triazine, 2-[2-hydroxy-4-(2-hydroxy-3-octyloxy-propyloxy)phenyl]-4,6-bi(2,4-dimethyl)-1,3,5-triazine, 2-[4-(dodecyloxy/tridecyloxy-2-hydroxypropoxy)-2-hydroxy-phenyl]-4,6-bis(2,4-dimethylphenyl)-1,3,5-triazine, 2-[2-hydroxy-4-(2-hydroxy-3-dodecyloxy-propoxy)phenyl]-4,6-bis(2,4-dimethylphenyl)-1,3,5-triazine, 2-(2-hydroxy-4-hydroxy)phenyl-4,6-diphenyl-1,3,5-triazine, 2-(2-hydroxy-4-methoxyphenyl)-4,6-diphenyl-1,3,5-triazine, 2,4,6-tris[2-hydroxy-4-(3-butoxy-propoxy)phenyl]-1,3,5-triazine, 2-(2-hydroxyphenyl)-4-(4-methoxyphenyl)-6-phenyl-1,3,5-triazine, and 2-{2-hydroxy-4-[3-(2-ethylhexyl-1-oxy)-2-hydroxypropyloxy]phenyl)}-4,6-bis(2,4-dimethylphenyl)-1,3,5-triazine; and the oxanilide is selected from the group consisting of 4,4′-dioctyloxyoxanilide, 2,2′-diethoxyoxanilide, 2,2′-dioctyloxy-5,5′-di-tert-butoxanilide, 2,2′-didodecyloxy-5,5′-di-tert-butoxanilide, 2-ethoxy-2′-ethyloxanilide, N,N′-bis(3-dimethylaminopropyl)oxamide, 2-ethoxy-5-tert-butyl-2′-ethoxanilide and its mixture with 2-ethoxy-2′-ethyl-5,4′-di-tert-butoxanilide, mixtures of o- and p-methoxy-disubstituted oxanilides and mixtures of o- and p-ethoxy-disubstituted oxanilides.

Examples of suitable dyes include, but are not limited to the following:

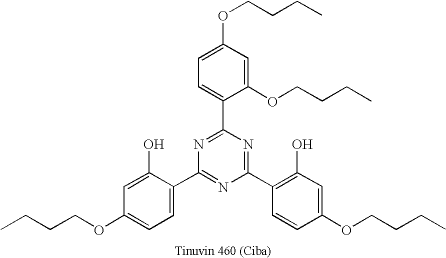

The third component of the optical element of this invention has a maximum peak absorption at a wavelength greater than 700 nm (infrared ray-absorbing dyes). The infrared ray-absorbing dyes favorably used in the invention include commercially available dyes and publicly known dyes described in literature. Specific examples thereof include azo dyes, metal complex salt azo dyes, pyrazolone azo dyes, anthraquinone dyes, phthalocyanine dyes, carbonium dyes, quinonimine dyes, methine dyes, cyanine dyes and the like. Typical examples of these infrared ray-absorbing dyes include cyanine dyes described in JP-A Nos. 58-125246, 59-84356, 59-202829 and 60-78787; methine dyes described in JP-A Nos. 58-173696, 58-181690, and 58-194595, and others; naphthoquinone dyes described in JP-A Nos. 58-112793, 58-224793, 59-48187, 59-73996, 60-52940, and 60-63744, and others; squarylium dyes described in JP-A No. 58-112792 and others; cyanine dye described in U.K. Patent No. 434,875; and the like.

Particularly preferable among these dyes are cyanine dyes. A general formula of cyanine dye is shown below: 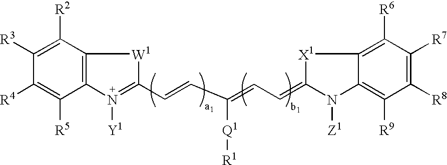
wherein a₁ and b₁ vary from 0 to 5; W¹ and X¹ may be the same or different and are selected from the group consisting of —CR¹⁰R¹¹, —O—, —NR¹², —S—, and —Se; Q¹ is a single bond or is selected from the group consisting of —O—, —S—, —Se—, and —NR³; Y¹ and Z¹ may be the same or different and are selected from the group consisting of —(CH₂)_{c}—CO₂H, —CH₂—(CH₂—O—CH₂) d—CH₂—CO₂H, —(CH₂)ₑ—NH₂, —CH₂—(CH₂—O—CH₂) f—CH₂—NH₂, —(CH₂) g—N(R₁₄)—(CH₂)ₕ—CO₂H, and —(CH₂)ᵢ—N(R₁₅)—CH₂—(CH₂—O—CH₂)ⱼ—CH₂—CO₂H; R¹ and R¹⁰ to R¹⁵ may be same or different and are selected from the group consisting of -hydrogen, C1-C10 alkyl, C1-C10 aryl, C1-C10 alkoxyl, C1-C10 polyalkoxyalkyl, —CH₂(CH₂—O—CH₂)_{c}—CH₂—OH, C₁-C₂₀ polyhydroxyalkyl, C1-C10 polyhydroxyaryl, —(CH₂) d—CO₂H, —CH₂—(CH₂—O—CH₂) e—CH₂—CO₂H, —(CH₂) f—NH₂, and —CH₂—(CH₂—O—CH₂)_{g}—CH₂—NH₂; c, e, g, h, and i vary from 1 to 10; d, f and j vary from 1 to 100; and R² to R⁹ may be the same or different and are selected from the group consisting of hydrogen, C1-C10 alkyl, C1-C10 aryl, hydroxyl, C1-C10 polyhydroxyalkyl, C1-C10 alkoxyl, amino, C1-C10 aminoalkyl, cyano, nitro and halogen.

Examples of suitable IR dyes include, but are not limited to the following:

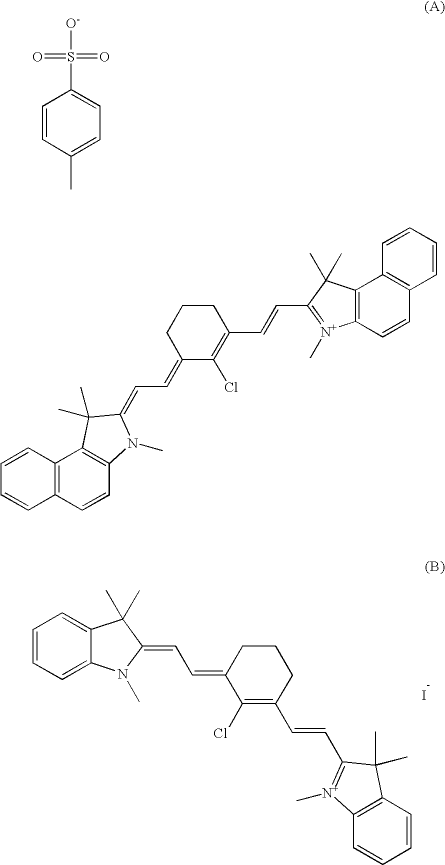

New optical materials can be made containing component 1, preferably a polymer, and component 2, the UV absorbing compound. The methods of synthesizing the materials include mixing (UV absorbing compound doping), forming associating species through electrostatic interaction, and covalently attaching the UV absorbing group to the polymer chain. These various methods are known to those skilled in the art.

By suitable selection of the polymer and UV absorbing group, the birefringence dispersion can be controlled to obtain an optical element exhibiting reverse dispersion and simultaneously satisfying the following two conditions:
|Δnₜₕ(λ₂)|−|Δnₜₕ(λ₁)|>0 for 400 nm<λ₁<λ₂<650 nm (i)
Δnₜₕ(450 nm)/Δnₜₕ(590 nm)<0.98, preferably 0.95 and more preferably 0.9 (ii)

In one embodiment the optical element is an optical film wherein the absolute value of the birefringence of the film at 590 nm is higher than 104. In one suitable embodiment the optical element is a retardance film. Preferably the in-plane retardation of the film is from 0 to 300 nm, more preferably the in-plane retardation of the film is from 20 to 200 nm, and most preferably the in-plane retardation of the film is from 25 to 100 nm. Also preferably the out-of-plane retardation of the film is from −300 to +300 nm, more preferably out-of-plane retardation of the film is from −200 to +200 nm, and most preferably the out-of-plane retardation of the film is from −100 to +100 nm.

The following examples illustrate the practice of this invention. They are not intended to be exhaustive of all possible variations of the invention. Parts and percentages are by weight unless otherwise indicated. All birefringence and retardation values are at 590 nm unless otherwise stated.

### EXAMPLES

In the following experiments, the out-of-plane birefringence Δnₜₕ and transmittance were measured using a Woollam® M-2000V Variable Angle Spectroscopic Ellipsometer.

UV absorbing material

UV dye-1

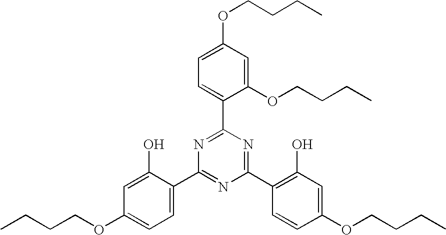

The term “D” is defined as follows as the ratio of the birefringence at wavelength 450 nm to the birefringence at 590 nm: D=Δnₜₕ (450 nm)/Δnₜₕ (590 nm). The exemplary compositions of Inventive Examples 1 and 2 and Comparative Example C-1 are shown in Table 2. The compositions were mixed together in a solvent mixture of toluene/dichlormethane. Their optical properties are also included in Table 2.

TABLE 2

| | | Tinuvin | thick- | | |
|---|---|---|---|---|---|
| | PS | 460 | ness | bire- | |
| | % | % | micron | fringence | D |
| Example-1 | 80 | 20 | 1.98 | 0.0011 | 0.83 |
| Example-2 | 85 | 15 | 2.45 | 0.0013 | 0.92 |
| Comparative Example C-1 | 100 | 0 | 1.26 | 0.0056 | 1.05 |

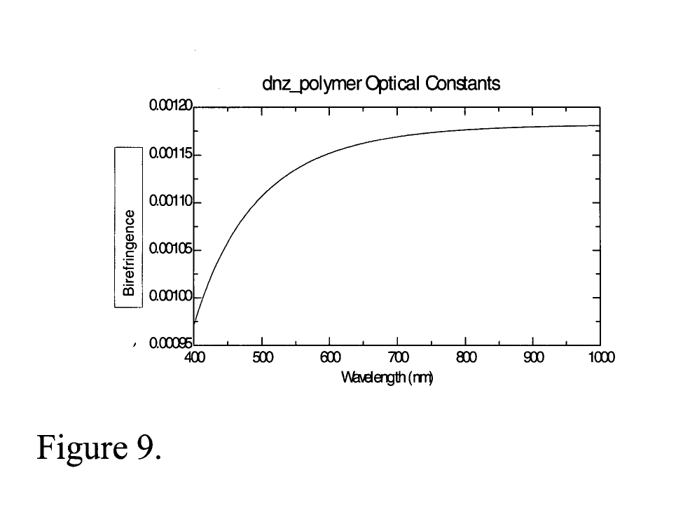

Based on the results shown in Table 2, Inventive example 1 and Inventive Example 2 show a reverse birefringence dispersion of DΔnₜₕ<1, while the Comparative Example C-1 has a normal birefringence dispersion of DΔnₜₕ>1. The birefringence spectrum of Example 1 is shown in FIG. 9 and has a reverse birefringence.

The invention has been described in detail with particular reference to certain preferred embodiments thereof, but it will be understood that variations and modifications can be effected within the spirit and scope of the invention.

1. An optical element comprising a first component having a birefringence dispersion of D1>1, and a second component having a birefringence dispersion of D2>1 and a maximum peak absorption at a wavelength less than 400 nm; wherein D2>D1; wherein the birefringence ratio at any wavelength of the first and second component is Δn1/Δn2<0; and wherein the optical element has a reverse birefringence dispersion of D<1.

2. The optical element of claim 1 wherein the optical element is an optical film.

3. The optical element of claim 2 wherein the amount by volume of the second component is less than the amount of the first component.

4. The optical element of claim 3 wherein the amount by volume of the second component is greater than 5% of the amount of the first component.

5. The optical element of claim 3 wherein the amount by volume of the second component is greater than 15% of the amount of the first component.

6. The optical element of claim 2 wherein the optical film has a reverse birefringence dispersion of D<0.95.

7. The optical element of claim 2 wherein the first component is a polymer.

8. The optical element of claim 2 wherein the absolute value of the birefringence of the film at 590 nm is higher than 10⁻⁴.

9. The optical element of claim 8 wherein the second component has a molecular weight of less than 2000.

10. The optical element of claim 8 wherein the second component has a maximum peak absorption at a wavelength between 300 nm and 400 nm.

11. The optical element of claim 8 wherein the second component has an maximum extinction coefficient high than 10000.

12. The optical element of claim 9 wherein the second component is an organic component.

13. The optical element of claim 7 wherein the second component is covalently attached to the polymer.

14. The optical element of claim 7 wherein the polymer is transparent in the visible range.

15. The optical element of claim 2 wherein the first material has a birefringence dispersion of D1<1.05.

16. The optical element of claim 7 wherein the polymer is a vinyl polymer or a condensation polymer.

17. The optical element of claim 7 wherein the polymer is polystyrene.

18. The optical element of claim 2, wherein said film is a retardance film.

19. The optical element of claim 2 wherein the in-plane retardation of the film is from 0 to 300 nm.

20. The optical element of claim 2 wherein the in-plane retardation of the film is from 20 to 200 nm.

21. The optical element of claim 2 wherein the in-plane retardation of the film is from 25 to 100 nm.

22. The optical element of claim 2 wherein the out-of-plane retardation of the film is from −300 to +300 nm.

23. The optical element of claim 2 wherein the out-of-plane retardation of the film is from −200 to +200 nm.

24. The optical element of claim 2 wherein the out-of-plane retardation of the film is from −100 to +100 nm.

25. The optical element of claim 2 further comprising a third component having a maximum peak absorption at a wavelength of greater than 700 nm.

26. The optical element of claim 1 wherein the optical element is transparent in the visible region.

27. An LCD polarizer film composite comprising a first component having a birefringence dispersion of D1>1 and a second component having a birefringence dispersion of D2>1 and a maximum peak absorption at a wavelength less than 400 nm, wherein the birefringence ratio of the first and second component is delta n1/delta n2<0, wherein the optical film has a reverse birefringence dispersion of D<1.
